(19) United States
(12) Patent Application Publication
(10) Pub. No.: US 2014/0263244 A1
(43) Pub. Date: Sep. 18, 2014

(54) ELECTRICAL WELDING MACHINE TRANSPORTER AND SYSTEM

(71) Applicant: LINCOLN GLOBAL, INC., City of Industry, CA (US)

(72) Inventor: Carmen DeLisio, Mentor, OH (US)

(73) Assignee: LINCOLN GLOBAL, INC., City of Industry, CA (US)

(21) Appl. No.: 13/804,332

(22) Filed: Mar. 14, 2013

(51) Int. Cl. B23K 37/02

(52) U.S. Cl. CPC B23K 37/0294
USPC 219/132; 180/65.1; 180/6.7; 180/167

(57) ABSTRACT

A transporter for an electrical welding machine having an auxiliary electrical power output includes: a chassis, the chassis being adapted to removably carry the welding machine; a propulsion mechanism mounted to the chassis; an electrical motor operable to drive the propulsion mechanism to propel the transporter on land; and an interface unit on the transporter, the interface unit being operable to receive electrical power output from the welding machine. The transporter is operable to transport the welding machine using electrical power from the welding machine auxiliary electrical power output.

### BACKGROUND OF THE INVENTION

The present invention relates to electrical welding machines and, in particular, to a removable welding machine transporter powered by the welding machine.

Large welding machines can be difficult to transport in areas of difficult terrain. They are too heavy or the distances too great to be manually carried, but the terrain may limit the use of large vehicles such as trucks. Some smaller vehicles exist, but are just smaller version internal combustion engine vehicles.

In addition, it is possible to provide a special purpose vehicle that includes a welder integrated into the small internal combustion engine driven small vehicle. The welder is an integral part of the vehicle and it is not practical to use the welder independently from the vehicle. This greatly limits the possible uses of the welding machine itself.

### SUMMARY OF THE INVENTION

A transporter for an electrical welding machine having an auxiliary electrical power output includes: a chassis, the chassis being adapted to removably carry the welding machine; a propulsion mechanism mounted to the chassis; an electrical motor operable to drive the propulsion mechanism to propel the transporter on land; and an interface unit on the transporter, the interface unit being operable to receive electrical power output from the welding machine. The transporter is operable to transport the welding machine using electrical power from the welding machine auxiliary electrical power output.

An electrical welding system includes an electrical welding machine portion including an auxiliary electrical power output; and a transporter portion. The transporter portion includes: a chassis, the chassis being adapted to removably carry the welding machine portion; a propulsion mechanism mounted to the chassis; an electrical motor operable to drive the propulsion mechanism to propel the system on land; and an interface unit on the transporter portion, the interface unit being operable to receive electrical power output from the welding machine portion. The transporter portion is operable to transport the welding machine using electrical power from the welding machine portion auxiliary electrical power output.

### BRIEF DESCRIPTION OF THE DRAWINGS

FIG. 1 is a schematic diagram of a rear elevation view showing an example that includes aspects of the invention;

FIG. 2 is a schematic diagram of a side elevation view of the example of FIG. 1;

FIG. 3 is a schematic diagram of a top plan view of another example that includes aspects of the invention;

FIG. 4 is a schematic diagram of a side elevation view of still another example that includes aspects of the invention; and

FIG. 5 is a block diagram of an example of a welding machine.

### DESCRIPTION OF THE PREFERRED EMBODIMENTS

Referring to FIGS. 1 and 2, a transporter 10 for an electrical welding machine 30 is shown with the welding machine 30 in position for mounting on the transporter 10.

The transporter 10 includes a chassis 12, propulsion mechanisms 14 attached to the chassis 12 and electric motors 16 that during operation provide motive force to the propulsion mechanisms 14. An interface unit 18 is provided on the transporter 10 for electrical connection between the transporter 10 and the welding machine 30.

The welding machine 30 includes an integral source of electric power sufficient to perform desired electrical welding and power the transporter 10. Typically, the electrical power source would be an internal combustion engine-driven generator or alternator. Other sources are possible, for example, a fuel cell or other sources suitable for inclusion as an integral source for the welding machine 30, or the welding machine may be a hybrid with a combination of an integral internal combustion engine-driven generator or alternator and a fuel cell or battery. An auxiliary electrical power output 32 is provided on the welding machine for use in connecting an electrical power cable 22 from the welding machine 30 to the interface unit 18. The power cable 22 may advantageously include electrical connectors that removably connect to mating connectors of the power output 32 and the interface unit 18.

The chassis 12 can be any structure with the size, strength and durability to support and transport the welding machine 30 and the other elements of the transporter 10. The propulsion mechanisms 14 may include suspension elements and, in the embodiment illustrated in the drawings, may include tracked drive elements 24. In some applications, it may be suitable to substitute wheels for tracks.

The motors 16 may be, for example, AC or DC motors. For example, a wheel or track may have its own motor or power-dividing gear trains may be used to split drive power from a motor to drive more than one track or wheel. It is possible to mount a motor 16 to either the chassis 12 or to a propulsion mechanism 14, depending on a chosen propulsion mechanism configuration.

In addition, it is also possible to use a motor 16 to drive one or more unshown hydraulic motors to power in-turn the propulsion mechanisms 14.

Referring to FIG. 3, in addition to being the electrical power input for the transporter, the interface unit 18 may include control circuitry for controlling the motors 16 and/or the propulsion mechanisms 14. The interface unit 18, while shown schematically as a block in the drawings, may, for example, be more distributed within the transporter 10 and, as well as include an unshown cabled remote control. The interface unit 18 may also include a receiver 26 for wireless remote control operation of the transporter 10 via a wireless remote control. For example, infra-red or RF control could be used. Possible RF control could utilize, for example, Bluetooth or Wi-Fi control links or links commonly used in radio-controlled cars, boats and airplanes. An antenna 28 can be used to receive RF signals for the receiver 26.

For transportation, the welding machine 30 is removably mounted on the transporter 10 by, for example, brackets 34. For example, unshown clamps on the transporter 10 may be used to clamp the brackets 34 to the transporter 10. It may be desirable, for example, to just bolt the brackets to the transporter in cases where the speed of a clamp is not needed. With the cable 22 attached between the welding machine 30 and the transporter 10, the welding machine and transporter 10 combination become a welding machine system 40 (FIG. 4) that transports the welding machine 30 using the electrical power from the welding machine 30 to power the transporter 10.

Referring to FIG. 4, the welding machine 30 is illustrated mounted on the transporter 10 with the power cable 22 now in an unshown internalized, more protected, location between the welding machine 30 and the transporter 10. An operator 50 may walk with the welding machine system 40 or ride an independent vehicle accompanying the welding machine system 40 and control the welding machine system 40 by remote control.

As a further option, a trailer 42 that may be hitched to the welding machine system 40 may be provided for the operator 50 to ride in. For example, the trailer 42 may be a wheeled chariot or sulky-like vehicle for the operator to stand or sit on and includes a mounted remote control 44 with which the operator 50 pilots the welding machine system 40, by either wired or wireless communication with the welding machine system 40. For example, the operator 50 would control the speed and direction of the welding machine system 40.

The welding machine system 40 provides the flexibility of using the welding machine 30 with or without a transporter 10. In addition, the cost, weight and complexity of the transporter 10 are reduced by not needing to have its own power source. The welding machine system 40 provides a more compact, lighter and efficient system for transporting a welding machine over difficult terrain.

Referring to FIG. 5, an exemplary electrical welding machine 30′ includes an internal combustion engine 52 that drives a generator 54 to supply power to the welder circuitry 56 which supplies electrical energy suitable for welding to the welding electrodes 58. Electrical power from the welding machine 30′ can be tapped off as appropriate.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A transporter for an electrical welding machine having an auxiliary electrical power output, said transporter comprising:
a chassis, said chassis being adapted to removably carry said welding machine;
a propulsion mechanism mounted to said chassis;
an electrical motor operable to drive said propulsion mechanism to propel said transporter on land; and
an interface unit on said transporter, said interface unit being operable to receive electrical power output from said welding machine, wherein said transporter is operable to transport said welding machine using electrical power from said welding machine auxiliary electrical power output.

2. A transporter according to claim 1, wherein said propulsion mechanism is a tracked propulsion mechanism.

3. A transporter according to claim 1, wherein said interface unit further comprises controls for operation of said transporter device.

4. A transporter according to claim 3, wherein said interface is radio controlled.

5. A transporter according to claim 1, further comprising an operator trailer, said trailer being operably hitched to said transporter, said trailer providing transportation for an operator of the transporter.

6. A transporter according to claim 5 wherein said trailer further comprises controls for operation of said transporter device.

7. An electrical welding system comprising:
an electrical welding machine portion including an auxiliary electrical power output; and
a transporter portion, said transporter portion comprising:
a chassis, said chassis being adapted to removably carry said welding machine portion;
a propulsion mechanism mounted to said chassis;
an electrical motor operable to drive said propulsion mechanism to propel said system on land; and
an interface unit on said transporter portion, said interface unit being operable to receive electrical power output from said welding machine portion, wherein said transporter portion is operable to transport said welding machine using electrical power from said welding machine portion auxiliary electrical power output.

8. A system according to claim 7, wherein said propulsion mechanism is a tracked propulsion mechanism.

9. A system according to claim 7, wherein said interface unit further comprises controls for operation of said transporter portion.

10. A system according to claim 9, wherein said interface is radio controlled.

11. A system according to claim 7, further comprising an operator trailer, said trailer being operably hitched to said transporter portion, said trailer providing transportation for an operator of the system.

12. A system according to claim 11 wherein said trailer further comprises controls for operation of said system.
